(19) United States
(12) Patent Application Publication
(10) Pub. No.: US 2006/0158643 A1
(43) Pub. Date: Jul. 20, 2006

(54) Method and system of inspecting mura-defect and method of fabricating photomask

(75) Inventor: Teruaki Yoshida, Kumamoto (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/299,832

(22) Filed: Dec. 13, 2005

(30) Foreign Application Priority Data
Dec. 13, 2004 (JP) P2004-360196

(51) Int. Cl. G01N 21/88

(52) U.S. Cl. 356/237.5

(57) ABSTRACT

In a mura-defect inspection method which inspects a mura-defect generated in a repeated pattern of a photomask 50 having a repeated pattern that a large number of unit patterns are regularly arranged, an area having a repeated pattern to be a target for a mura-defect inspection is specified as an inspection area from an overall image of a photomask taken by an image pickup camera 21 of a pattern information acquiring unit 20, pattern information about the repeated pattern is acquired from the image of the repeated pattern in the inspection area taken by a microscope 22, an inspection condition for the mura-defect inspection by a mura-defect inspection apparatus 10 is decided based on the pattern information, and the mura-defect inspection apparatus conducts the mura-defect inspection based on the inspection condition.

This application claims foreign priority based on Japanese Patent application No. 2004-360196, filed Dec. 13, 2004, the contents of which is incorporated herein by reference in its entirety.

### BACKGROUND OF THE INVENTION

1. Field of the Invention

The present invention relates to a method and a system of inspecting a mura-defect which detect a mura-defect in pattern of an image device, or a mura-defect in pattern of a photomask for fabricating an image device, and a method of fabricating a photomask.

2. Description of the Related Art

Conventionally, for image devices such as an image pickup device and a display device, or for a photomask for use in fabricating these devices, a mura-defect inspection has been known as one of the inspection items for inspecting the patterns formed on the surface thereof. The mura-defect is an error having different regularities that have been unintentionally generated in patterns regularly arranged, and the defect is generated by some causes during fabrication process steps.

When a mura-defect exists in an image pickup device and a display device, a mura-defect, sensitivity unevenness, and display unevenness occur, which ends up deteriorating the device performance. Also in the photomask for use in fabricating the image pickup device and the display device, when a mura-defect occurs in patterns of a photomask, that mura-defect is transferred onto the patterns of an image device, resulting in the performance of the image device being deteriorated.

Conventionally, the mura-defect in patterns of the image device and in patterns of the photomask as described above cannot be detected in pattern inspection for individual patterns in many cases because micro defects are regularly arranged in general. However, when an area is observed as a whole, the defect can be differently identified from the other parts. Therefore, the mura-defect inspection is mainly conducted by visual inspection such as oblique lighting inspection by human eyes.

On the other hand, aiming for the inspection of an image device substrate, such as a liquid crystal TFT substrate, an apparatus of inspecting a mura-defect is proposed such as disclosed in JP Hei 10-300447. The mura-defect inspection apparatus according to JP-A-10-300447 irradiates light onto the surface of a substrate, and the scattered light from the edge part of patterns formed on the surface is observed to detect a mura-defect.

However, the mura-defect inspection as a visual inspection as described above has a problem such that because of its subjective-oriented test conducted by the individual inspectors, the variations can not be eliminated in the inspection results which tends to largely depend on their subjective evaluations. Therefore, a mura-defect in patterns of a photomask and an image device might not be detected highly accurately.

Furthermore, the mura-defect inspection apparatus that is disclosed in JP-A-10-300447 has a difficulty of detecting a mura-defect in patterns of an image device itself, but not to detect a mura-defect in patterns on the photomask that is used for fabricating such an image device.

Moreover, in patterns (repeated patterns) of the photomask and the image device as well, pattern information such as the shape or pitch of individual patterns (unit patterns) might be varied in accordance with the types of test objects. In such a circumstance, the inspection condition for mura-defect should be changed in accordance with a specific pattern information about the specific repeated patterns. However, the mura-defect inspection apparatus according to JP-A-10-300447 is not to change the inspection condition for the mura-defect inspection in accordance with pattern information about the repeated pattern that needs to undergo inspection. Consequently, it cannot detect a mura-defect highly accurately.

### SUMMARY OF THE INVENTION

The invention has been made in consideration of the circumstances, and an object of the invention is to provide a method and a system of inspecting a mura-defect which can conduct a mura-defect inspection effectively and highly accurately, and a method of fabricating a photomask.

A mura-defect inspection method of the invention according to aspect 1 is a mura-defect inspection method which inspects a mura-defect generated in a repeated pattern of a test object having a repeated pattern that a large number of unit patterns are regularly arranged, the method including: specifying an inspection area, to being a test target for a mura-defect inspection, from an overall image of the test object; acquiring a pattern information of the repeated pattern from an image of the repeated pattern corresponding to the inspection area; determining an inspection condition for the mura-defect inspection based on the pattern information; and performing the mura-defect inspection based on the inspection condition.

In the invention according to aspect 1, a mura-defect inspection method of the invention according to aspect 2, wherein the test object is an image device or a photomask for use in fabricating that image device.

A mura-defect inspection system of the invention according to aspect 3 is a mura-defect inspection system which inspects a mura-defect generated in a repeated pattern of a test object having a repeated pattern that a large number of unit patterns are regularly arranged, the system including: a pattern information acquiring means which enables an inspection area to be specified from an overall image of the test object, said inspection area to being a test target for a mura-defect inspection, and acquires a pattern information of the repeated pattern from an image of the repeated pattern corresponding to the inspection area; and a mura-defect inspection module means which inspects a mura-defect generated in the repeated pattern based on an inspection condition decided that is determined based on the pattern information acquired at the pattern information acquiring module.

In the invention according to aspect 3, a mura-defect inspection method of the invention according to aspect 4, wherein the test object is an image device or a photomask for use in fabricating that image device.

A method of fabricating a photomask of the invention according to aspect 5 is a method of fabricating a photomask in which a photomask having a predetermined shielding film pattern on a light transmissive substrate, the method including:

a shielding film pattern forming step which forms a shielding film pattern formed having a repeated pattern which is arranged such that a large number of unit patterns are regularly arranged on the light transmissive substrate; and

a mura-defect inspecting step which performs a mura-defect inspection which is comprised of: method according to claim 5 to inspect a mura-defect generated in the repeated pattern; specifying an inspection area, being a test target for a mura-defect inspection, from an overall image of the test object; acquiring a pattern information of the repeated pattern from an image of the repeated pattern corresponding to the inspection area;

determining an inspection condition for the mura-defect inspection based on the pattern information; and performing the mura-defect inspection based on the inspection condition.

According to the invention of aspect 1, 2 or 5, before conducting the mura-defect inspection, the inspection area to be the test target for the mura-defect inspection is specified from the overall image of the test object, pattern information about the repeated pattern is acquired from the image of the repeated pattern in the inspection area, and the inspection condition for the mura-defect inspection is decided based on the pattern information. Therefore, the inspection condition for the mura-defect inspection can be optimized in accordance with the repeated pattern to be the test target, and thus inspection of a mura-defect generated in the repeated pattern of the test object can be done effectively and highly accurately.

According to the invention of aspect 3 or 4, before the mura-defect inspection module conducts the mura-defect inspection, the pattern information acquiring module allows the inspection area to be specified from the overall image of the test object, the inspection area to be the test target of the mura-defect inspection, pattern information about the repeated pattern is acquired from the image of the repeated pattern in the inspection area, and the inspection condition for the mura-defect inspection by the mura-defect inspection module is decided based on pattern information about the repeated pattern acquired at the pattern information acquiring module. Thus, the inspection condition can be optimized in accordance with the repeated pattern to be the test target. Consequently, inspection of a mura-defect generated in the repeated pattern of the test object can be done effectively and highly accurately.

### BRIEF DESCRIPTION OF THE DRAWINGS

FIG. 1 is a system configuration diagram illustrating an embodiment of a mura-defect inspection system according to the invention.

FIG. 2 is a perspective view illustrating a state of performing an overall image capture process done by a pattern information acquiring unit shown in FIG. 1.

FIG. 3 is a perspective view illustrating a state of performing a pattern image capture process done by a pattern information acquiring unit shown in FIG. 1.

FIG. 4 is a perspective view illustrating a state of inspecting a mura-defect done by a mura-defect inspection apparatus shown in FIG. 1.

FIG. 5 is a plan view illustrating a repeated pattern in a photomask shown in FIGS. 1 and 4.

FIG. 6 is a flow chart illustrating the operation done by the mura-defect inspection system in FIG. 1.

### DESCRIPTION OF THE PREFERRED EMBODIMENTS

Embodiments of the present invention will be described hereinbelow by reference to the drawings. Unless otherwise specifically defined in the specification, terms have their ordinary meaning as would be understood by those of ordinary skill in the art.

Hereinafter, the best mode of carrying out the invention will be described with reference to the drawings.

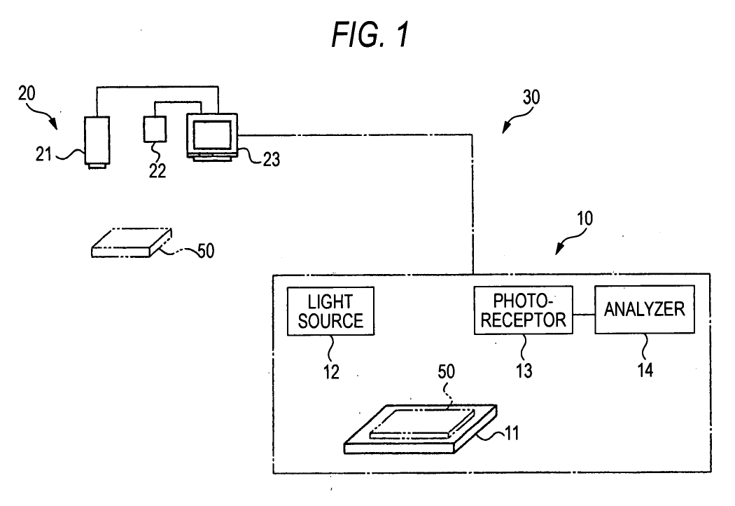

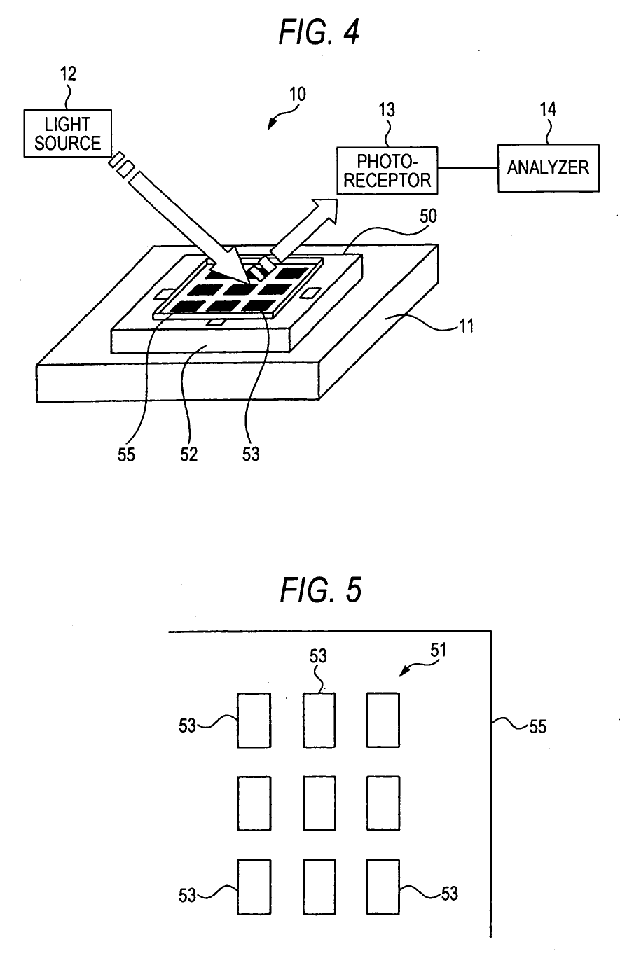

FIG. 1 is a system configuration diagram illustrating an embodiment of a mura-defect inspection system according to the invention. FIG. 4 is a perspective view illustrating an inspecting state of a mura-defect performed by the mura-defect inspection apparatus shown in FIG. 1.

A mura-defect inspection system 30 shown in FIG. 1 is a system which detects a mura-defect generated in a repeated pattern 51 (FIG. 5) formed on the surface of a photomask 50 being a test object, which is configured to have a pattern information acquiring unit 20 being a pattern information acquiring module, and a mura-defect inspection apparatus 10 being a mura-defect inspection module. The photomask 50 is an exposure mask for use in fabricating an image device.

Here, the image device is such a device that a large number of pixel patterns finally undergo image processing or image display, and an image pickup device and a display device are named. For the image pickup device, solid state image devices such as CCD, CMOS, and VMIS are typical ones. Furthermore, for the display device, a liquid crystal display device, a plasma display device, an EL display device, an LED display device, and a DMD display device are typical ones. Therefore, more specifically, the pixel patterns forming the image pickup plane of the image pickup device are repeated patterns forming a light receiving unit such as CCD and CMOS. Moreover, more specifically, the pixel patterns forming the display plane of the display device are repeated patterns for thin film transistors, a counter substrate, and a color filter of a liquid crystal display panel.

The photomask 50 has a desired repeated pattern 51 (FIG. 5) formed of a shielding pattern formed by partially removing a shielding film such as a chromium film on a surface 52A of the transparent substrate 52 such as glass. The repeated pattern 51 is a pattern used for transfer of a large number of pixel patterns for the image device using lithography, which is configured in which a large number of unit patterns 53 are regularly arranged as corresponding to the pixel patterns. Numeral 55 in FIGS. 4 and 5 denotes a chip on which the repeated pattern 51 is formed, for example, the pattern is made by about 5×5 on the photomask 50.

A fabrication method of the photomask 50 has a shielding film pattern forming step which forms a shielding film pattern formed of the repeated pattern 51 that a large number of the unit patterns 53 are regularly arranged, and a mura-defect inspecting step which conducts a mura-defect inspection method using the mura-defect inspection system 30 shown in FIG. 1 to detect a mura-defect generated in the repeated pattern 51.

In the shieldlng film pattern forming step, first, a shielding film is formed on a transparent substrate 52 (FIG. 4), and a resist film is formed on the shielding film. Subsequently, an electron beam or laser beam of a writing unit is irradiated onto the resist film for writing, and a predetermined pattern is exposed. Then, the written part and the non-written part are selectively removed to form a resist pattern. After that, the resist pattern is used as a mask to etch the shielding film, and the repeated pattern 51 formed of a large number of the unit patterns 53 (FIG. 5) is formed on the shielding film to form a shielding film pattern.

In the shielding film pattern forming step described above, when the pattern is written on the resist film by electron beam or laser beam scanning, a seam is generated depending on the beam scan width and the beam diameter, and an error caused by writing failure sometimes periodically occurs in the seam in every written unit, causing a mura-defect to occur.

The mura-defect inspection system shown 30 in FIG. 1 is a system which detects a mura-defect generated in the repeated pattern 51 in the photomask 50. In this system, the mura-defect inspection apparatus 10 is configured to have a stage 11, a light source 12, a photoreceptor 13, and an analyzer 14, as shown in FIG. 4. The stage 11 is a stage on which the photomask 50 is placed. Furthermore, the light source 12 is placed above on one side of the stage 11, which irradiates light onto the repeated pattern 51 on the surface of the photomask 50 from obliquely above.

The photoreceptor 13 is placed above on the other side of the stage 11, which receives the reflected light having reflected from the repeated pattern 51 of the photomask 50, particularly the scattered light having scattered at the edge part of the unit pattern 53 in the repeated pattern 51, and converts it to received light data. For example, for the photoreceptor 13, an image pick up sensor such as a CCD line sensor or a CCD area sensor is used. In the received light data converted by the photoreceptor 13, the regularity of the received light data is disturbed when a mura-defect occurs in the repeated pattern 51 of the photomask 50. Therefore, the analyzer 14 analyzes the received light data to detect a mura-defect.

Although a pattern information acquiring unit 20 of the mura-defect inspection system 30 shown in FIG. 1 is described later in detail, it is a unit which acquires pattern information about the repeated pattern 51 of the photomask 50. Based on this pattern information, the inspection conditions for mura-defect inspection in the mura-defect inspection apparatus 10 described above are decided (for example, the incident angle of the irradiated light to be irradiated onto the photomask 50 from the light source 12, and the scaling factor of image pickup for the photoreceptor 13, etc.).

In the mura-defect inspecting step in the fabrication method of the photomask 50, a mura-defect inspection method using the mura-defect inspection system 30 is conducted to inspect (detect) a mura-defect generated in the repeated pattern 51 of the photomask 50 in which the inspection condition of the mura-defect inspection apparatus 10 is decided based on pattern information about the repeated pattern 51 acquired at the pattern information acquiring unit 20, light is irradiated onto the repeated pattern 51 of the photomask 50 from the light source 12 of the mura-defect inspection apparatus 10 based on the inspection condition, the photoreceptor 13 receives the scattered light having scattered at the edge part of the unit pattern 53 in the repeated pattern 51, and the analyzer 14 analyzes received light data.

The pattern information acquiring unit 20 shown in FIG. 1 is configured to have an image pickup camera 21 which is capable of shooting the overall photomask 50, a microscope 22 which is capable of shooting the repeated pattern 51 of the photomask 50, and an image process display device 23 which captures images from the image pickup camera 21 and the microscope 22 for processing and display.

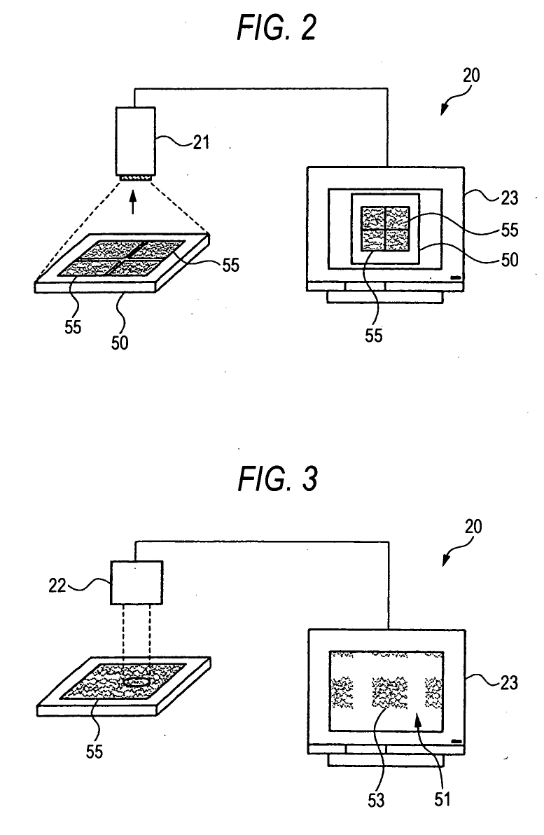

As shown in FIG. 2, the image pickup camera 21 shoots the overall photomask 50, and the overall image of the photomask 50 is captured at the image process display device 23 to conduct an overall image capture process. The photomask 50 includes the repeated pattern 51 not to be the test target for a mura-defect, in addition to the repeated pattern 51 to be the test target for a mura-defect. The image process display device 23 is configured to allow specifying an area having the repeated pattern 51 to be the test target for a mura-defect as an inspection area on the overall image of the photomask 50. This specification is done for every single or multiple chips 55, for example.

As shown in FIG. 3, the microscope 22 is configured to allow shooting the repeated pattern 51 in the specified inspection area. An image of the repeated pattern 51 is captured into the image process display device 23 to conduct a pattern image capture process. The image process display device 23 acquires pattern information about the repeated pattern 51 from the image of the repeated pattern 51 captured and displayed. The pattern information is a shape and a pitch of the unit patterns 53 forming the repeated pattern 51.

Then, based on the pattern information, the mura-defect inspection apparatus 10 decides the inspection condition for conducting a mura-defect inspection. For example, the inspection condition is the incident angle of the irradiated light irradiated from the light source 12 to the photomask 50, the light being decided in accordance with the shape of the unit pattern, and the scaling factor of image pickup for the photoreceptor 13 decided in accordance with the pitch of the unit pattern 53. The decision of the inspection condition is selected and decided by an inspector based on pattern information about the repeated pattern 51 acquired at the image process display device 23. Alternatively, when a correspondence table of pattern information to the inspection condition is stored in the image process display device 23, the image process display device 23 may decide the inspection condition from acquired pattern information based on the correspondence table.

Based on the inspection condition thus decided, the mura-defect inspection apparatus 10 inspects (detects) a mura-defect generated in the repeated pattern 51 of the photomask 50 as described above.

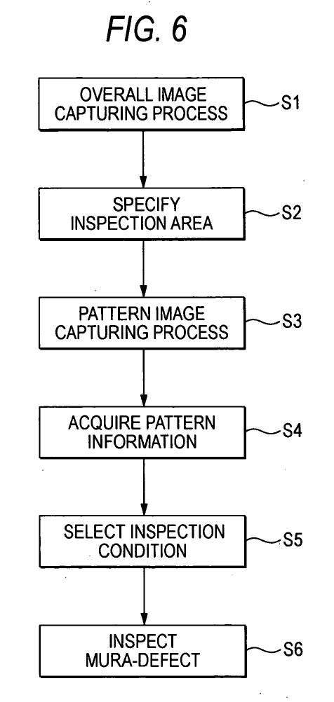

Next, the operation of the mura-defect inspection system 30 configured as described above will be described with reference to a flow chart in FIG. 6.

First, the overall image capture process is conducted in which the image pickup camera 21 of the pattern information acquiring unit 20 shoots the overall photomask 50, and the image process display device 23 captures the overall image of the photomask 50 for display (S1). Subsequently, an inspector specifies an area having the repeated pattern 51 to be the test target for a mura-defect as an inspection area on the image of the photomask 50 in the image process display device 23 (S2).

Then, the pattern image capture process is conducted in which the microscope 22 shoots the repeated pattern 51 for the inspection area, and the image process display device 23 captures the image of the repeated pattern 51 for display (S3). Subsequently, pattern information about the repeated pattern 51 (for example, the shape and pitch of the unit pattern 53, etc.) is acquired from the image of the repeated pattern 51 in the image process display device 23 (S4).

The inspector selects and decides the inspection condition for performing the mura-defect inspection in the mura-defect inspection apparatus 10 based on the acquired pattern information (S5). After that, the mura-defect inspection apparatus 10 inspects (detects) a mura-defect generated in the repeated pattern 51 of the photomask 50 based on the inspection condition (S6).

With the configuration as described above, the embodiment exerts the following advantages.

Before the mura-defect inspection apparatus 10 inspects a mura-defect generated in the repeated pattern 51 of the photomask 50, the pattern information acquiring unit 20 is used to specify the area having the repeated pattern 51 to be the target for the mura-defect inspection as the inspection area from the overall image of the photomask 50 taken by the image pickup camera 21, pattern information about the repeated pattern 51 is acquired from the microscopic image of the repeated pattern 51 in the inspection area, and the inspection condition for a mura-defect by the mura-defect inspection apparatus 10 is decided based on pattern information about the repeated pattern 51 acquired with the use of the pattern information acquiring unit 20. Therefore, even though pattern information about the repeated pattern 51 is not well-defined in the photomask 50, the inspection condition for the mura-defect inspection can be optimized in accordance with the repeated pattern 51 to be the test target. Consequently, inspection of a mura-defect generated in the repeated pattern 51 of the photomask 50 can be done by the mura-defect inspection apparatus 10 effectively and highly accurately.

As described above, the invention has been described based on the embodiment, but the invention will not be limited thereto.

For example, in the embodiment, the case is described in which the test object is the photomask 50, and the mura-defect inspection system 30 is the system which detects a mura-defect generated in the repeated pattern 51 of the photomask 50 for use in fabricating the image device. However, the test object may be an image device such as an image pickup device and a display device. In this case, the mura-defect inspection system 30 acquires individual items of pattern information by the pattern information acquiring unit 20 in a pixel pattern forming an image pickup plane in an image pickup device (more specifically, a repeated pattern forming a light receiving unit such as CCD and CMOS), or in a pixel pattern forming a display plane in a display device (more specifically, a repeated pattern of thin film transistors, a counter substrate, and a color filter of a liquid crystal display panel), it decides the inspection condition for the mura-defect inspection based on the pattern information, and it uses the mura-defect inspection apparatus 10 to detect a mura-defect generated in the pixel pattern based on the inspection condition.

Furthermore, the test object may be a photomask for use in fabricating a semiconductor memory such as DRAM and SRAM. In this case, the mura-defect inspection system 30 acquires pattern information about the repeated pattern of the photomask by the pattern information acquiring unit 20, it decides the inspection condition for the mura-defect inspection based on the pattern information, and it uses the mura-defect inspection apparatus 10 to detect a mura-defect generated in the repeated pattern based on the inspection condition. Therefore, a mura-defect such as local CD error can be inspected.

Moreover, the photoreceptor 13 in the mura-defect inspection apparatus 10 is described which receives light having scattered at the edge part of the unit pattern 53 in the repeated pattern 51 of the photomask 50, but it may receive transmitted light that passes between the unit patterns 53 in the repeated pattern 51 of the photomask 50, particularly among the transmitted light, it may receive diffracted light having diffracted at the edge part of the unit pattern 53.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A mura-defect inspection method which inspects a mura-defect generated in a repeated pattern of a test object having a repeated pattern where a large number of unit patterns are regularly arranged, the method comprising:
specifying an inspection area, being a test target for a mura-defect inspection, from an overall image of the test object;
acquiring a pattern information of the repeated pattern from an image of the repeated pattern corresponding to the inspection area;
determining an inspection condition for the mura-defect inspection based on the pattern information; and
performing the mura-defect inspection based on the inspection condition.

2. The mura-defect inspection method according to claim 1, wherein the test object is an image device or a photomask used for fabricating that image device.

3. A mura-defect inspection system which inspects a mura-defect generated in a repeated pattern of a test object having a repeated pattern where a large number of unit patterns are regularly arranged, the system comprising:
a pattern information acquiring means which enables an inspection area to be specified from an overall image of the test object, said inspection area being a test target for a mura-defect inspection, and acquires a pattern information of the repeated pattern from an image of the repeated pattern corresponding to the inspection area; and
a mura-defect inspection means which inspects a mura-defect generated in the repeated pattern based on an inspection condition that is determined based on the pattern information.

4. The mura-defect inspection system according to claim 3, wherein the test object is an image device or a photomask used for fabricating that image device.

5. A method of fabricating a photomask in which a photomask having a predetermined shielding film pattern is formed on a light transmissive substrate, the method comprising:
a shielding film pattern forming step which forms a shielding film pattern having a repeated pattern which is arranged such that a large number of unit patterns are regularly arranged on the light transmissive substrate; and
a mura-defect inspecting step which performs a mura-defect inspection which is comprised of:
specifying an inspection area, being a test target for a mura-defect inspection, from an overall image of the test object;
acquiring a pattern information of the repeated pattern from an image of the repeated pattern corresponding to the inspection area;
determining an inspection condition for the mura-defect inspection based on the pattern information; and
performing the mura-defect inspection based on the inspection condition.
